(19) United States
(12) Patent Application Publication
(10) Pub. No.: US 2026/0095639 A1
(43) Pub. Date: Apr. 2, 2026

(54) LASER SPECKLE FLOW SENSORS ADAPTIVE TO DIFFERENT COVER STACK THICKNESSES

(71) Applicant: Apple Inc., Cupertino, CA (US)

(72) Inventors: Yongkang Gao, Sunnyvale, CA (US); Tong Chen, Fremont, CA (US); David D. Dashevsky, San Jose, CA (US)

(21) Appl. No.: 19/327,977

(22) Filed: Sep. 12, 2025

Related U.S. Application Data
(60) Provisional application No. 63/700,334, filed on Sep. 27, 2024.

(51) Int. Cl. H04N 23/55; G01P 3/36; G02B 27/48; H04N 23/56; H04N 23/95

(52) U.S. Cl. CPC H04N 23/55; G02B 27/48; H04N 23/56; H04N 23/95; G01P 3/36

(57) ABSTRACT

An opto-electronic device includes a laser speckle flow sensor that is positioned interior to the opto-electronic device and configured to sense through a cover stack of the opto-electronic device. The laser speckle flow sensor includes a laser light source that is operable to emit a beam of light, and an image sensor having a two-dimensional (2D) array of pixels. The image sensor is positioned to receive a portion of the beam of light redirected from a target. One or more of an axis of the beam of light intersecting a surface of the cover stack at a non-perpendicular angle, at least one optical element positioned to receive the beam of light and change a mode field diameter (MFD) of the beam of light, a control circuit that selects the laser light source from among a set of switchable laser light sources, or other described features enable the laser speckle flow sensor to sense through a range of different cover stack thicknesses.

### CROSS REFERENCE TO RELATED APPLICATION

This application claims priority to U.S. Provisional Application No. 63/700,334, titled “LASER SPECKLE FLOW SENSORS ADAPTIVE TO DIFFERENT COVER STACK THICKNESSES,” filed Sep. 27, 2024, the entire disclosure of which is hereby incorporated, for all purposes, as if fully set forth herein.

### FIELD

The described embodiments generally relate to laser speckle flow sensors.

### BACKGROUND

A laser speckle flow sensor may be used for object (target) tracking. A laser speckle flow sensor may generally include a laser light source that is operable to emit a beam of light, and an image sensor that is positioned to detect a laser speckle pattern generated by object-surface interference with the beam of light. For example, when an object (e.g., a finger) moves laterally with respect to the sensing plane of the image sensor, the laser speckle pattern generated by object-surface interference with the beam of light moves laterally on the sensing plane. Frame-to-frame movement of the laser speckle pattern may be captured by the image sensor, and images (or pixel values) obtained from the image sensor may be processed (e.g., compared) to reconstruct the frame-to-frame movement of the object.

### SUMMARY

Embodiments of the systems, devices, methods, and apparatus described in the present disclosure are directed to laser speckle flow sensors that are adaptive to different cover stack thicknesses.

Traditionally, a laser speckle flow sensor is designed to function beneath a module or device cover through which the laser speckle flow sensor emits and receives light. For example, emitted light may pass through the cover and interfere with a target. The interference may produce a laser speckle pattern that can be sensed by the laser speckle flow sensor. However, in some cases, a user may modify a cover stack that includes the cover through which the laser speckle flow sensor emits and receives light. For example, a user may apply a screen protector to a mobile phone's or tablet computer's cover glass, and/or the user may place their device within a case that has a light-transmissive panel. These modifications to the cover stack through which a laser speckle flow sensor emits and receives light may induce flare on an image sensor of the laser speckle flow sensor; distort the laser speckle pattern on the image sensor; and/or reduce laser speckle contrast in a laser speckle pattern image acquired by the image sensor. These changes may interfere with the laser speckle flow sensor's ability to track movement of an object (target) and/or accurately estimate a distance or speed of movement of the object. Described herein are laser speckle flow sensors (and optical sensors, more generally) that are able to sense through, or adapt their sensing to, a range of cover stack thicknesses.

In a first aspect, the present disclosure describes an opto-electronic device. The opto-electronic device may include a cover stack that separates an interior of the opto-electronic device from an exterior of the opto-electronic device, and a laser speckle flow sensor that is positioned in the interior of the opto-electronic device. The laser speckle flow sensor may include a laser light source operable to emit a beam of light, and an image sensor having a two-dimensional (2D) array of pixels. The image sensor may be positioned to receive a portion of the beam of light redirected from a target. The axis of the beam of light may intersect a surface of the cover stack at a non-perpendicular angle.

In a second aspect, the present disclosure describes another opto-electronic device. The opto-electronic device may include a laser speckle sensor. The laser speckle flow sensor may include a laser light source operable to emit a beam of light, an image sensor having a 2D array of pixels, and at least one optical element positioned to receive the beam of light. The image sensor may be positioned to receive a portion of the beam of light redirected from a target. The at least one optical element may be configured to change a mode field diameter (MFD) of the beam of light, from a native MFD to a target MFD.

In a third aspect, the present disclosure describes another opto-electronic device. The opto-electronic device may include a cover stack, a laser speckle flow sensor, and a control circuit. The cover stack may separate an interior of the opto-electronic device from an exterior of the opto-electronic device. The laser speckle flow sensor may be positioned in the interior of the opto-electronic device and include a set of light sources and an image sensor. At least a first laser light source in the set of laser light sources and a second laser light source in the set of laser light sources may be operable to emit respective first and second beams of light. The image sensor may be positioned to receive a portion of at least the first beam of light or the second beam of light, with the portion of at least the first beam of light or the second beam of light being redirected from a target. The control circuit may be operable to independently switch each of the first laser light source and the second laser light source on and off.

In addition to the aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example elevation of an opto-electronic device that includes a laser speckle flow sensor;

FIG. 2 shows an opto-electronic device including all of the same components described with reference to FIG. 1, but with an increased baseline between its laser light source and image sensor;

FIG. 3 shows an opto-electronic device including all of the same components described with reference to FIG. 1;

FIG. 4 shows an opto-electronic device including all of the same components described with reference to FIG. 2;

FIGS. 5A-5C illustrate examples of some of the laser speckle patterns that may be acquired by the laser speckle flow sensors and electronic devices described herein;

FIG. 6 shows another opto-electronic device that includes a laser speckle flow sensor;

FIG. 7 shows an opto-electronic device that includes all of the same components described with reference to FIG. 3, in addition to one or more optical elements that change an MFD of a beam of light;

FIGS. 8 and 9 show example alternative embodiments of the opto-electronic device shown in FIG. 7;

FIG. 10 shows an example plan view of an image sensor;

FIGS. 11A and 11B show an example of a device that may include a laser speckle flow sensor; and

FIG. 12 shows an example electrical block diagram of an electronic device that includes a laser speckle flow sensor.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments and appended claims.

Traditional laser speckle flow sensors typically consist of a laser light source and driving circuitry on the emitter side, and an image sensor and digital signal processing (DSP) circuitry on the receiver side. The driving circuitry, image sensor, and DSP circuitry may be integrated on the same silicon die, together with necessary power and input/output (I/O) interface management circuitry. A laser speckle flow sensor module assembly may also include a case, a substrate, a flexible (flex) circuit, et cetera.

A laser speckle flow sensor may in some cases be installed behind an IR-transmissive cover, such as a glass, crystal, or plastic cover. Part or all of an object (target) to be sensed by the laser speckle flow sensor, such as a user finger moving on top of the cover, can be illuminated by the laser light source of the laser speckle flow sensor. Frame-to-frame movement of the illuminated target (e.g., a finger) may be captured by evaluating changes in a laser speckle pattern acquired by the image sensor and processed by the DSP circuitry. For example, the DSP circuitry may execute a laser speckle flow algorithm to reconstruct frame-to-frame movement of the object.

Laser speckle flow sensors operate on the basis that a target moving with respect to a surface generates interference that produces a laser speckle pattern. Compared to a traditional, imaging-based, optical flow sensor, the tracking performance of a laser speckle flow sensor may be less dependent on object surface texture variation, surface working distance, and other parameters. In some embodiments, a laser speckle flow sensor can be incorporated into a lens-free package or module, which can make it more versatile for near field object tracking.

A laser speckle flow sensor is usually designed for optimal performance under specific system usage conditions, including a specific cover type and thickness, a specific module-to-interior cover surface air gap, a specific target-to-exterior cover surface air gap (if any), et cetera.

When a laser speckle flow sensor is integrated into a consumer electronic device, the device user may sometimes supplement or modify the IR-transmissive cover over the laser speckle flow sensor. For example, the user may choose to place one or more IR-transmissive protection layers on or over the cover. Such protection layers may include, for example, a screen protector, a phone case, or a tablet computer sleeve. Sometimes, a user may place more than one protection layer on or over the cover, such as a screen protector and a phone case. Such user modification of system conditions is a major challenge and failure mode for laser speckle flow tracking.

In some cases, an IR-transmissive protection layer may produce flare on the laser speckle flow sensor's image sensor (e.g., as a result of a new, additional, or altered specular reflection path caused by the additional thickness of the “cover stack” and/or a new or additional interface between dissimilar materials of the cover stack). Flare can obfuscate speckle features that are useful or needed for target movement tracking.

For purposes of this description, a “cover stack” is defined to be a set of one or more layers through which a laser speckle flow sensor needs to emit and receive light to sense movement of a target on a side of the cover stack opposite the laser speckle flow sensor. In some cases, a cover stack may include, for example, one or more of a screen protector; an IR-transmissive case; a layer of adhesive between a cover and a screen protector; an air gap between a cover and an IR-transmissive case; an air gap between a screen protector and an IR-transmissive case; a privacy screen; smudges on or between one or more protective layers; et cetera.

Described herein are new laser speckle flow sensors that are adaptive to different cover stack thicknesses. The described sensor architectures and methods of sensing ensure consistent laser speckle flow tracking performance and user experience (within limits) regardless of user modification of a cover stack over the laser speckle flow sensor.

The described laser speckle flow sensors may include an emitter or emission path optical design that provides a desired target illumination but mitigates or avoids flare from a cover stack, so long as the cover stack has a cover stack thickness within a cover stack thickness range of interest. For example, the emitter or emission path optical design may include control of one or more of a beam divergence, beam steering angle, beam polarization, et cetera. Such an optical design may be achieved using one or more of surface optics formed on a laser light source (e.g., an on-chip lens (OCL)), wafer level optics disposed on or over a laser light source, or module level optics disposed in a module that holds or houses the laser light source. In some embodiments, a laser speckle flow sensor may include multiple laser light sources (two or more light sources), with each laser light source being configured to emit a beam of light having a different set of parameters (e.g., different locations or orientations, different beam shaping, and so on), and a subset (or all) of the laser light sources may be switched on or off for sensing through a cover stack having a particular cover stack thickness.

The described laser speckle flow sensors may also or alternatively include an image sensor or optical reception path design that reduces the effects of flare or ambient light aggressors, or mitigates the downside of emitter or emission path optical design changes. For example, the pixel resolution of an image sensor may be increased (sometimes dynamically) to improve speckle contrast; or the pixels of an image sensor may be binned or not binned, to reduce, quantify, or limit the effects of flare; or a pixel level bandpass filter or polarizer may be used to reduce the effects of flare or ambient light aggressors.

The described laser speckle flow sensors may also or alternatively include module design factors that adjust an emitter-to-image sensor baseline spacing or other module parameters.

The described laser speckle flow sensors may also or alternatively include a control circuit (e.g., discrete circuits and/or a processor, for example) that receives or detects a cover stack thickness and configures the binning or non-binning of image sensor pixels, the enablement and disablement of particular laser light sources, and so on, to optimize laser speckle flow sensing through a particular cover stack thickness.

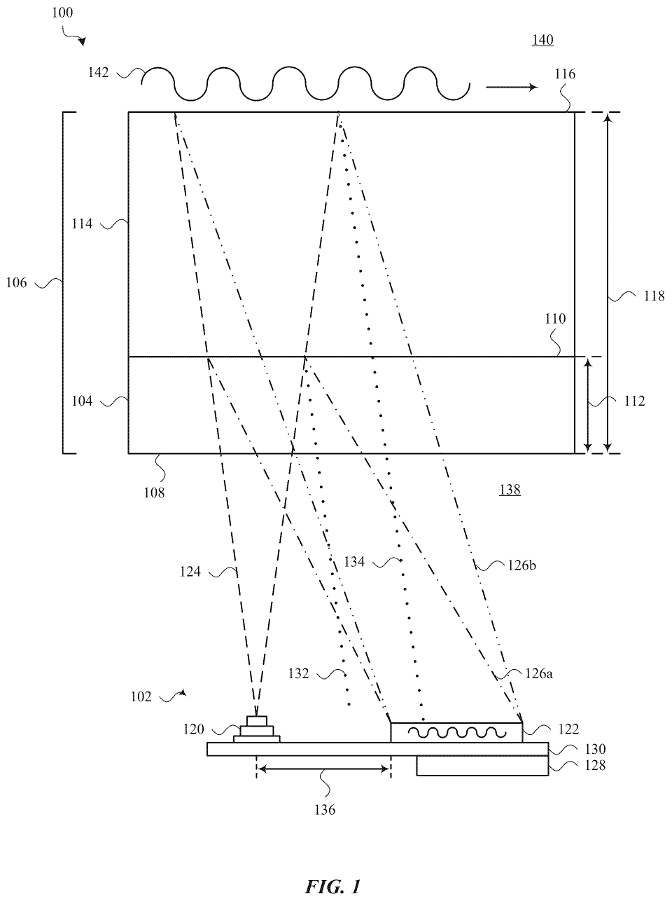

FIG. 1 shows an example elevation of an opto-electronic device 100 that includes a laser speckle flow sensor 102 (or more generally, an optical sensor). The laser speckle flow sensor 102 may be positioned below (or on a first side 138 of) a cover 104 that defines part or all of a cover stack 106. The laser speckle flow sensor 102 may be used to sense, or detect movement of, a target 142 (e.g., a finger) on a second side 140 of the cover stack 106. By way of example, the cover 104 may be formed of glass, crystal, or plastic. In some embodiments, the cover stack 106 may include more than one layer, of which one layer is the cover 104.

When the cover 104 is the sole or primary layer of the cover stack 106, the cover 104 may define an interior surface 108 and an exterior surface 110 of the cover stack 106, with the interior surface 108 and the exterior surface 110 separated by a cover thickness 112. In such embodiments, a thickness of the cover stack 106 is equal to the cover thickness 112.

When the cover 104 is only one layer of the cover stack 106, and the cover stack 106 also includes one or more of a user-provided screen protector 114, a light-transmissive panel or component of a device case, or other layer, the cover 104 may define an interior surface 108 of the cover stack 106, and the screen protector 114 (or another layer) may define an exterior surface 116 of the cover stack 106, with the interior surface 108 and the exterior surface 116 separated by a cover stack thickness 118. In such embodiments, the thickness 118 of the cover stack 106 may be much greater (e.g., 2x-3x greater), than the cover thickness 112.

Although a laser speckle flow sensor 102 may work well when emitting and receiving light through the cover 104, which cover 104 has a known thickness and is part of the design of the device 100, the performance of the laser speckle flow sensor 102 may deteriorate when one or more layers of unknown thickness and composition (e.g., screen protector 114) are added to the cover 104, thereby increasing the thickness of the cover stack 106. Decreased performance of the laser speckle flow sensor 102 may include, for example, decreased performance when attempting to track the presence and/or movement of a target 142 (e.g., a finger) on an exterior surface (e.g., exterior surface 110 or 116) of the cover stack 106.

The laser speckle flow sensor 102 may include a laser light source 120 and an image sensor 122. The laser light source 120 may be operable to emit a beam of light toward the interior surface 108 of the cover 104. All or a portion of the beam of light 124 may pass or refract through the cover stack 106 and optionally be redirected (e.g., reflected or scattered) by the target 142 (e.g., a finger), though portions of the beam of light 124 may also be redirected from surfaces of the cover stack 106, imperfections in the cover stack 106, and/or particles in the air between the laser light source 120 and the cover stack 106. In some embodiments, the laser light source 120 may include one or more coherent light sources, such as one or more vertical cavity surface-emitting lasers (VCSELs), edge-emitting lasers (EELs), vertical external-cavity surface-emitting lasers (VECSELs), quantum-dot lasers (QDLs), quantum cascade lasers (QCLs), or light-emitting diodes (LEDs) (e.g., one or more organic LEDs (OLEDs), resonant-cavity LEDs (RC-LEDs), micro LEDs (mLEDs), superluminescent LEDs (SLEDs), or edge-emitting LEDs), and so on.

In some embodiments, the laser light source 120 may be an IR light source, in which case the cover 104 (and cover stack 106) may be IR-transmissive, and the image sensor 122 may be configured or filtered to be IR-only sensitive. In other embodiments, the laser speckle flow sensor 102 may be configured to emit and sense near IR (NIR) light, ultraviolet (UV) light, or another wavelength (or range of wavelengths) of light, in a visible or non-visible range.

The image sensor 122 may have a two-dimensional (2D) array of pixels, and in some cases may be a complimentary metal-oxide semiconductor (CMOS) image sensor or single-photon avalanche diode (SPAD) array. The 2D array of pixels may be oriented parallel to the cover 104 (though it need not be). The image sensor 122 may image laser speckle that results from a portion of the light emitted by the laser light source 120 being redirected (e.g., scattered or reflected) from the target 142; surfaces 108, 110, 116; interfaces between surfaces (e.g., the interface between the cover 104 and screen protector 114); particles interior or exterior to the device 100; imperfections in the cover 104 or screen protector 114; and so on (and collectively, as light 126a or 126b).

During operation of the laser speckle flow sensor 102, the cover stack 106 may pass the beam of light 124 emitted by the laser light source 120 and light 126a (or 126b) that may or may not be received by the image sensor 122 (e.g., a portion of the light 124 emitted by the laser light source 120 that is redirected by a target 142). As shown, the target 142 may in some cases be a user's finger, with the finger defining a fingerprint having one or more ridges and valleys. The target 142 may be illuminated by the beam of light 124 as it touches or is moved on or near the cover stack 106. The target 142 (sometimes in combination with intermediary surfaces or particles, which surfaces or particles are not intended targets) may produce a laser speckle pattern in an image obtained from the image sensor 122. As the target 142 moves, intentionally or subtly, different laser speckle patterns may be obtained from the image sensor 122. When the frame rate of the image sensor 122 is sufficiently fast (e.g., substantially faster than the speed at which the target 142 is moved on the exterior surface 110), characteristics of a user's finger movement may be determined (e.g., whether the target 142 is moving, a direction of movement along the exterior surface 110, a speed of movement along the exterior surface 110, and in some cases, aspects of movement toward or away from the exterior surface 110). The characteristics of target movement (e.g., finger movement) may be determined by a control circuit 128 (e.g., a processor, or DSP circuitry) that is in communication with the image sensor 122 and/or a memory that temporarily stores image data read from the image sensor 122. In some embodiments, two or more of the image sensor 122, the laser light source 120, and the control circuit 128 may be mounted on the same printed circuit board (PCB) 130 and/or included in the same chip package or module.

Some of the light that is emitted by the laser light source 120 may specularly reflect from the interior surface 108 or an exterior surface 116 of the cover stack 106, or from interfaces between various layers of the cover stack 106 (e.g., the interface at surface 110). FIG. 1 illustrates a singular specular reflection path 132 from the surface 110 of the cover 104, and a singular specular reflection path 134 from the screen protector 114, but other specular reflection paths may exist. In some embodiments, the image sensor 122, laser light source 120, and their positions and orientations may be designed such that specular reflection paths from surfaces 108 and 110 of the cover 104 (and in some cases other specular reflection paths) do not impinge on the image sensor 122, thus avoiding flare (bright light that does not contain information pertaining to an image of a target (e.g., the target 142) and saturates one or more pixels of the image sensor 122). However, when a user adds additional layers to the cover stack 106, such as the layer defining the screen protector 114, specular reflection paths from the added layers (e.g., specular reflection path 134) may impinge on the image sensor 122, thereby causing flare. Flare may obscure useful features of a laser speckle pattern that the image sensor 122 might otherwise be able to acquire.

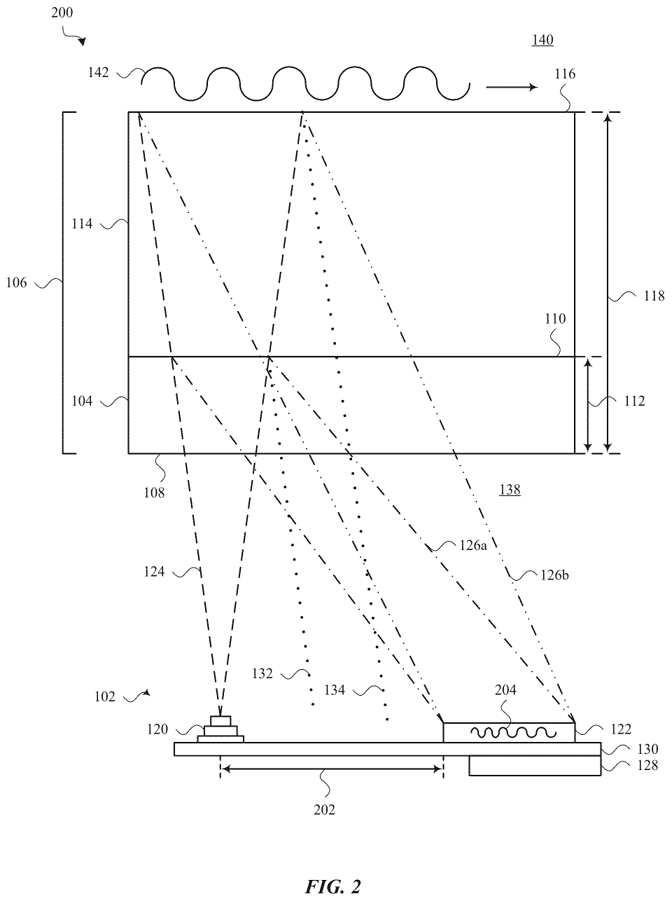

To reduce or eliminate flare on the image sensor 122, a baseline 136 between the laser light source 120 and the image sensor 122 may be increased. For example, FIG. 2 shows an opto-electronic device 200 including all of the same components described with reference to FIG. 1, but a baseline 202 between the laser light source 120 and the image sensor 122 has been increased relative to the baseline 136 of FIG. 1, such that the specular reflection path 134 from the exterior surface 116 of the screen protector 114 (and other, or all, specular reflection paths from the exterior surface 116, if any) no longer impinges on the image sensor 122, thus avoiding flare on the image sensor 122. In other embodiments, flare may be reduced by providing a baseline 202 that prevents a subset of stronger specular reflection paths from impinging on the image sensor 122, or by providing a baseline 202 that prevents a majority of (or higher concentration of) specular reflection paths from impinging on the image sensor 122. Increasing the baseline 202, however, may induce speckle distortion 204 (e.g., an increase or decrease in the size of at least some laser speckles with respect to other laser speckles) due to an increase in the chief ray angle (CRA) at which light 126a (or 126b) impinges on the image sensor 122. Speckle distortion may also depend, to some extent, on the size of the beam of light 124 (e.g., the MFD of the beam of light 124). Speckle distortion can induce tracking errors or failures.

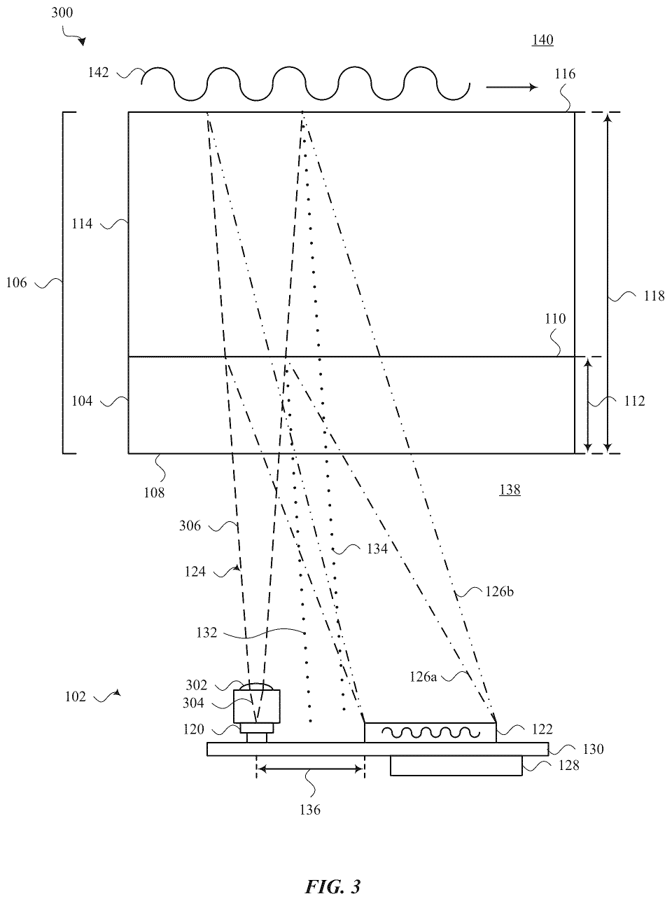

FIG. 3 shows another opto-electronic device 300 that includes all of the same components described with reference to FIG. 1. In the device 300, however, at least one optical element 302 (e.g., laser light source surface optics, such as an on-chip lens (OCL) formed in a substrate of the laser light source 120 (e.g., in a substrate of a backside illumination laser light source); wafer level optics, such as a lens attached to an epitaxial layer of the laser light source 120; and/or module level optics, such as a module lens positioned between the laser light source 120 and the cover stack 106 (and in some cases, a lens formed on or in the cover stack 106)) is positioned to receive the beam of light 124 and change an MFD of the beam of light 124, from a native MFD 304 (e.g., an MFD of the laser light source 120) to a target MFD 306. The optical element(s) 302 may reduce the divergence of the beam of light 124, such that the target MFD 306 is greater than the native MFD 304. In some embodiments, the optical element(s) 302 may include a collimating lens (e.g., a lens that tends to collimate a beam of light, such as a lens that truly collimates a beam of light, or a lens that approximately collimates a beam of light over a range of working distances, or a lens that substantially increases the MFD and narrows the divergence of a beam of light (e.g., by 50% or more)). In some cases, and as shown, an axis of the beam of light 124 may intersect a surface (or all surfaces) of the cover stack 106 at a perpendicular angle.

However, reducing the transmit divergence, without more, can also reduce the area that the beam of light 124 illuminates on the exterior surface (e.g., 110 or 116) of the cover stack 106, which can limit the maximum tracking speed (of a target) that can be achieved by the image sensor 122 (e.g., because an object moving too fast can move into and out of the tracking area of the beam of light 124 before the image sensor 122 acquires a sufficient number of image frames having overlapping speckle features, or a number of image frames having sufficient speckle feature overlap).

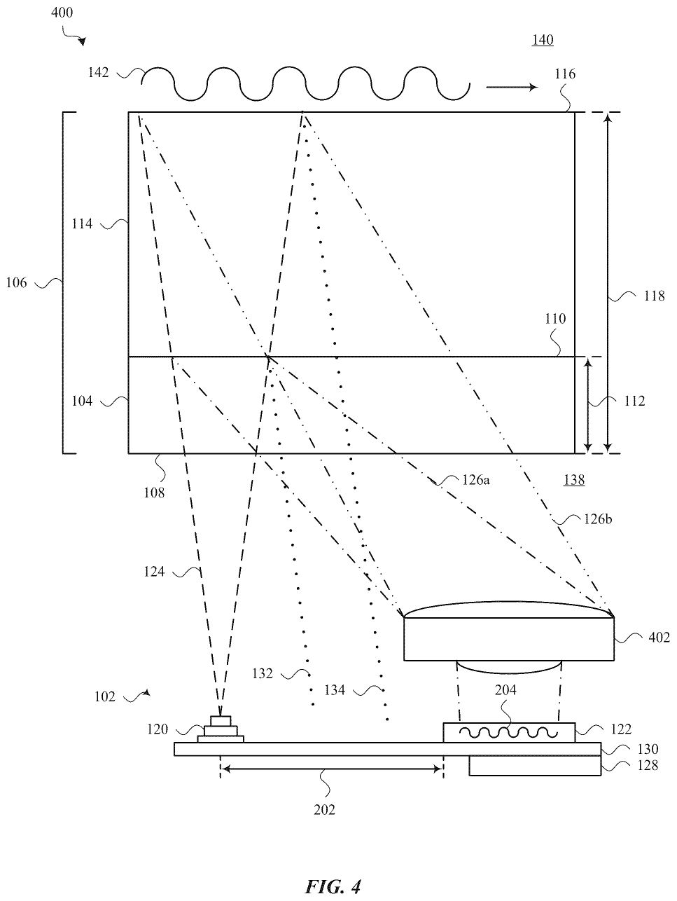

FIG. 4 shows an opto-electronic device 400 that includes all of the same components described with reference to FIG. 2. In the device 400, at least one optical element 402 is positioned between the cover stack 106 and the image sensor 122 and configured to screen out flare due to specular reflection paths for a range of cover stack thicknesses, materials, and/or cover stack surface or interface positions (e.g., specular reflection path 134). However, the optical element(s) 402, without more, can increase the size of the laser speckle flow sensor 102 as a whole (e.g., increase the size of a laser speckle flow sensor module), can block the laser speckle path for some or all cover stack configurations, and can introduce gain uncertainty for some cover stack thicknesses.

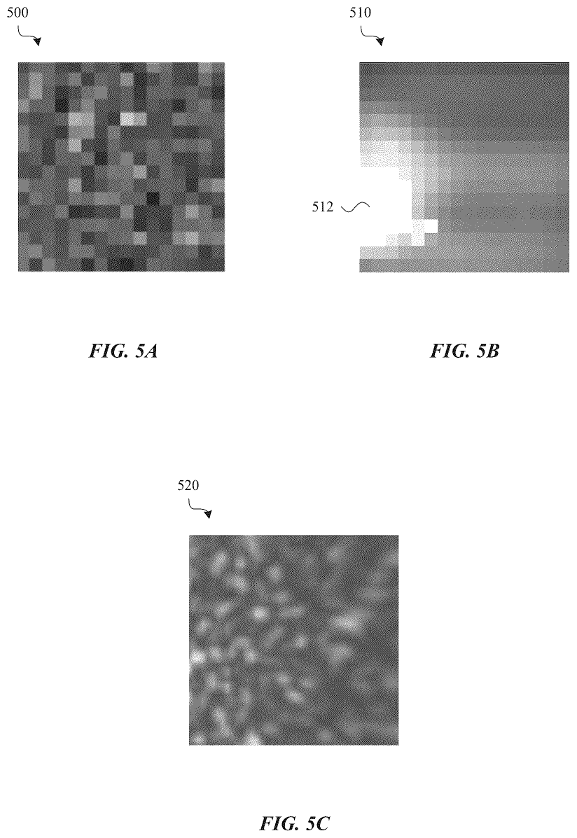

FIGS. 5A-5C illustrate examples of some of the laser speckle patterns that may be acquired by the laser speckle flow sensors and electronic devices described herein. FIG. 5A shows a laser speckle pattern 500 without flare, as might be acquired by the image sensor of the laser speckle flow sensor described with reference to FIG. 1 when disposed under a cover stack including only the cover described with reference to FIG. 1. In contrast, FIG. 5B shows a laser speckle pattern 510 with flare 512, as might be acquired by the image sensor of the laser speckle flow sensor described with reference to FIG. 1 when disposed under a cover stack including the cover and the screen protector described with reference to FIG. 1.

FIG. 5C shows a laser speckle pattern 520 with speckle distortion, as might be acquired by the image sensor of the laser speckle flow sensor described with reference to FIG. 2.

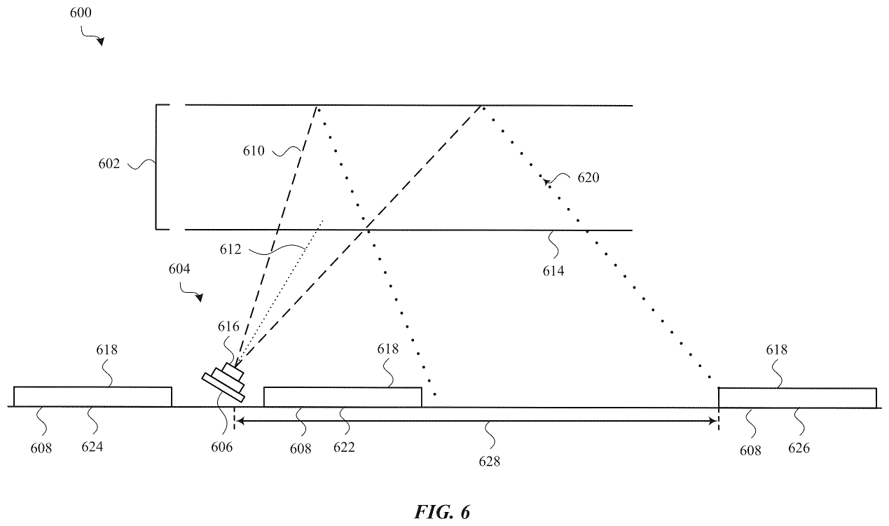

FIG. 6 shows an opto-electronic device 600 that includes a cover stack 602 and a laser speckle flow sensor 604. The laser speckle flow sensor 604 is positioned interior to the device 600, below the cover stack 602. As discussed with reference to FIG. 1, the thickness of the cover stack 602 may vary, depending on whether a user has placed protective layers such as a screen protector or a case over a cover of the cover stack 602.

The laser speckle flow sensor 604 may include a laser light source 606 and an image sensor 608. The laser light source 606 and image sensor 608 may be constructed or configured as described with reference to any of the laser speckle flow sensors or devices described herein.

As shown, the laser light source 606 may be operable to emit a beam of light 610, and an axis 612 of the beam of light 610 may intersect a surface 614 (e.g., the interior surface 614, or all surfaces) of the cover stack 602 at a non-perpendicular angle. Stated differently, a surface 616 of the laser light source 606 may be tilted with respect to the cover stack 602. In some embodiments, the tilt of the axis 612 may be achieved by tilting the laser light source 606 as a whole. Alternatively, the laser light source 606 may emit a beam of light such that an axis of the beam of light is perpendicular to a surface 614 (or all surfaces) of the cover stack 602, and a set of one or more optical elements disposed on the laser light source 606, or between the laser light source 606 and the cover stack 602, may tilt or steer the axis of the beam of light such that it intersects a surface 614 (or all surfaces) of the cover stack 602 at a non-perpendicular angle.

The image sensor 608 may be variously positioned, and in some cases may be positioned in position 622, 624, or 626. As shown in FIG. 6, and by way of example, the image sensor 608 may be disposed in position 622, and the surface 616 of the laser light source 606 may be tilted toward the image sensor 608, such that the axis 612 of the beam of light 610 leans toward the image sensor 608 and forms an acute angle with respect to a light-receiving surface 618 of the image sensor 608. The amount of tilt of the axis 612 can be selected such that specular reflection paths 620 of the beam of light 610, for a cover stack thickness range of interest, miss the light-receiving surface 618 of the image sensor 608, thereby decreasing the chance that the image sensor 608 will experience flare. In these embodiments, the image sensor 608 is positioned between the laser light source 606 and the specular reflection paths 620 for the cover stack thickness range of interest.

Alternatively, and also as shown in FIG. 6, the image sensor 608 may be disposed in position 624, and the surface 616 of the laser light source 606 may be tilted away from the image sensor 608, such that the axis 612 of the beam of light 610 leans away from the image sensor 608 and forms an obtuse angle with respect to the light-receiving surface 618 of the image sensor 608. In these embodiments, the specular reflection paths 620 may pass a first side of the laser light source 606, and the image sensor 608 may be positioned on a second side of the laser light source 606 (with the second side of the laser light source 606 being different from, or opposite to, the first side of the laser light source 606). This placement and orientation of the laser light source 606 and image sensor 608 also decreases the chance that specular reflection paths 620 impinge on the image sensor 608 and reduce the likelihood of the image sensor 608 experiencing flare.

As another alternative, and as also shown in FIG. 6, the image sensor 608 may be disposed in position 626, such that a baseline 628 between the laser light source 606 and the image sensor 608 is sufficiently large to prevent the specular reflection paths 620 from impinging on the image sensor 608 for a cover stack thickness range of interest.

In all of the embodiments described with reference to FIG. 6, the surface 616 of the laser light source 606 may be alternatively oriented parallel to a surface 614 (or all surfaces) of the cover stack 602, and the axis 612 of the beam of light 610 may be steered (or tilted) by at least one optical element that is positioned in a path of the beam of light 610, thereby causing the axis 612 to intersect a surface 614 (or all surfaces) of the cover stack 602 at a non-perpendicular angle.

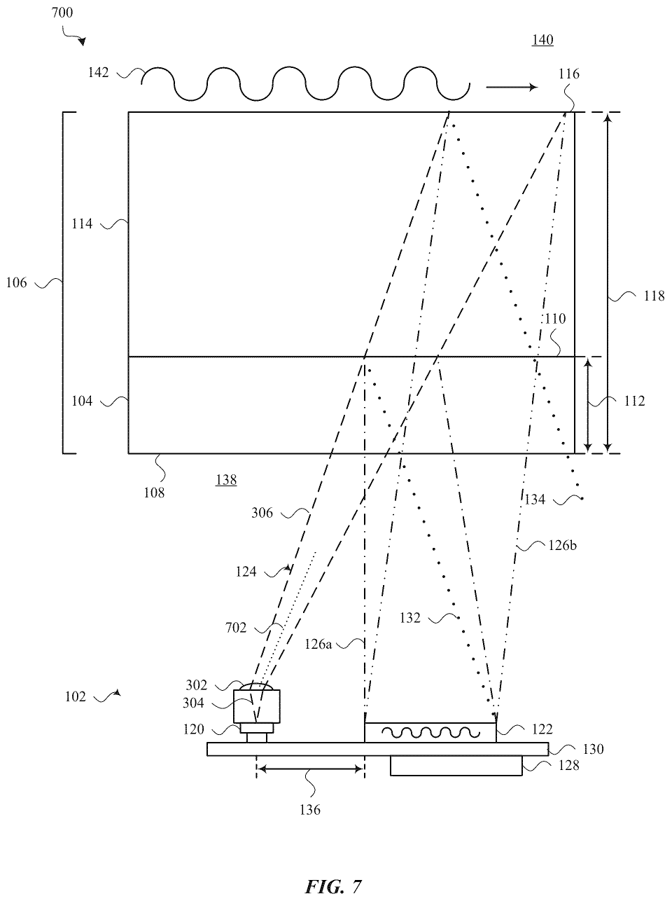

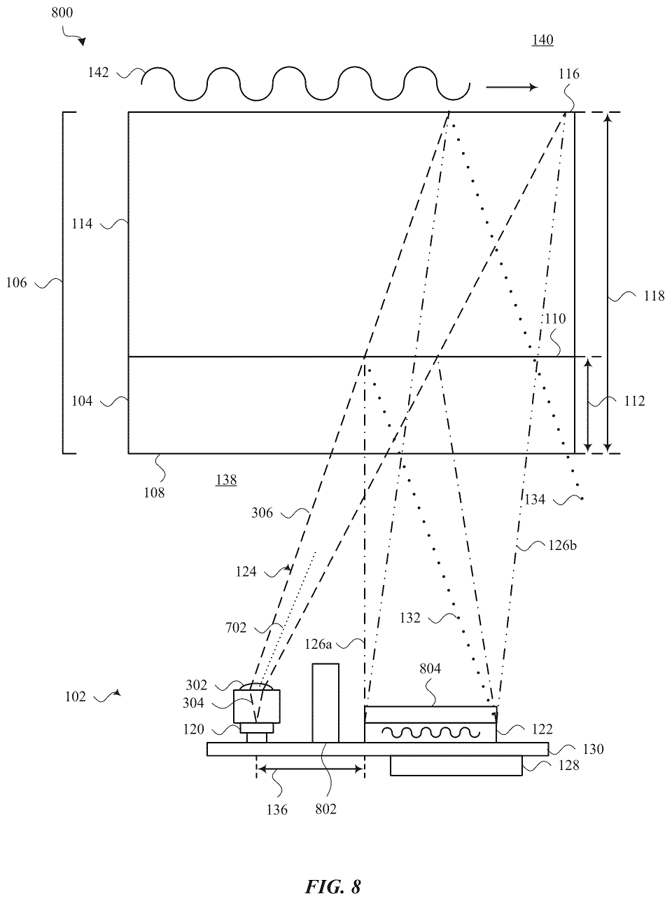

FIG. 7 shows an opto-electronic device 700 that includes all of the same components described with reference to FIG. 3. In the device 700, however, the at least one optical element 302 (e.g., laser light source surface optics, such as an OCL; wafer level optics; and/or module level optics) is positioned to receive the beam of light 124 and change an MFD and direction of the beam of light 124. The MFD may be changed from a native MFD (e.g., an MFD of the laser light source 120) to a target MFD. The direction of the beam of light 124 may be changed such that an axis 702 of the beam of light 124 tilts toward the image sensor 122 and intersects one or more (or all) surfaces (e.g., surfaces 108, 110, and 116) of the cover stack 106 at a non-perpendicular angle. The optical element(s) 302 may reduce the divergence of the beam of light 124, such that the target MFD is greater than the native MFD. In some embodiments, the optical element(s) 302 may include a collimating lens and a beam steering lens, which lenses may be separate optical elements or provided in a combined optical element.

Tilting the beam of light 124 tends to increase the size of the area that the beam of light 124 illuminates on the exterior surface (e.g., 110 or 116) of the cover stack 106, thus reversing at least some of the downside of reducing the transmit divergence of the beam of light 124. Tilting the beam of light 124, in combination with decreasing the transmit divergence of the beam of light 124, also helps reduce the chief ray angle at which light is redirected off the exterior surface 110 or 116 of the cover stack 106, which reduces speckle distortion on the image sensor 122.

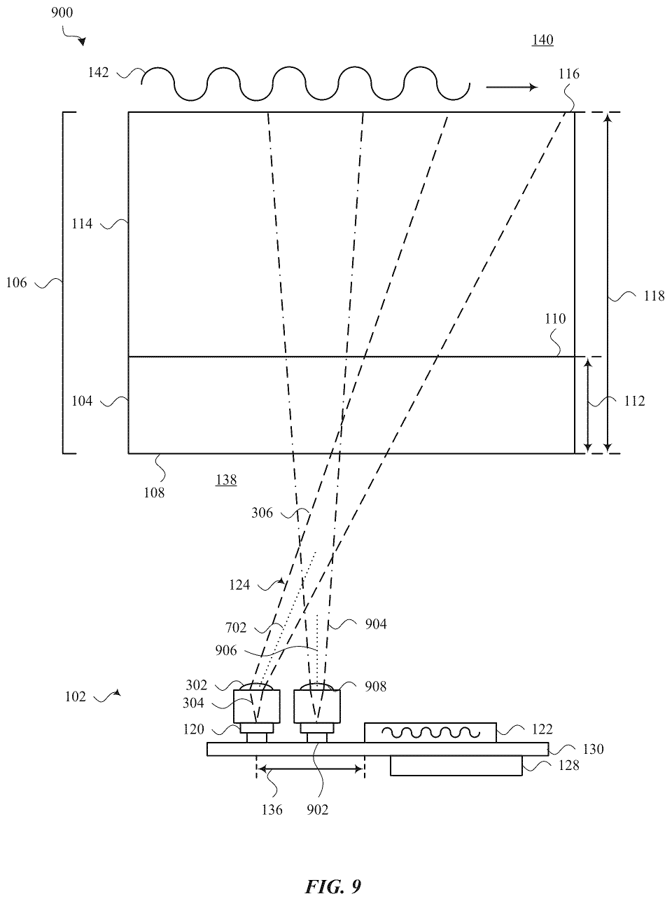

FIG. 8 shows an example alternative embodiment of the opto-electronic device shown in FIG. 7. The opto-electronic device 800 includes the laser light source 120, optical element(s) 302, and image sensor 122, along with two additions. The first addition is a wall 802, or other barrier structure, that is optically opaque to the beam of light emitted by the laser light source 120. The wall 802 may extend between the laser light source 120 and image sensor 122 and function to prevent any portion of the beam of light 124 from impinging on the image sensor 122 before entering the cover stack 106.

The second addition is a set of one or more filters 804, such as optical polarization filters or optical bandpass filters, disposed over one or more pixels of the image sensor 122. The filter(s) 804 may be used to shield one or more pixels of the image sensor 122 from flare. In some embodiments, the beam of light 124 emitted by the laser light source 120 may be polarization-locked to a particular polarization of emitted light (e.g., by means of a structure or configuration of the laser light source 120, or by means of the optical element(s) 302). One or more pixels of the image sensor 122 may be associated with a filter 804 that prevents the particular polarization of light emitted by the laser light source 120 from impinging on the image sensor 122. Because flare represents a reflection of light “as is”, without an alteration of its polarization, blocking the particular polarization of light emitted by the laser light source 120 will only allow light that does not represent flare to impinge on the image sensor 122. In some embodiments, different filters 804 over different pixels may block different polarizations of light. These embodiments may be useful when the laser light source 120 is not polarization locked, or when only a sampling of the light reflected from a target 142 is to be imaged by the image sensor 122.

By way of example, a set of filters 804 is shown on, or integrated with, each pixel of the image sensor 122. Alternatively, one or more filters 804 may be suspended above the image sensor 122 or attached to or formed on the interior surface 108 of the cover stack 106. Alternatively, the set of filters 804 may consist of a single filter, or may include one or more filters disposed over only some of the pixels of the image sensor 122 (e.g., over a subset of less than all pixels). In all cases, the filter(s) 804 may be positioned between the cover stack 106 and the image sensor 122.

Although the additions described with reference to FIG. 8 are described as additions to the embodiments shown in FIG. 7, the additions can similarly be made to any of the embodiments described herein. The additions may be added to any of the laser speckle flow sensors described herein individually or in combination.

FIG. 9 shows another example alternative embodiment of the opto-electronic device shown in FIG. 7. The opto-electronic device 900 includes the laser light source 120, optical element(s) 302, and image sensor 122. However, the laser light source 120 is a first laser light source in a set of laser light sources. By way of example, only a second laser light source 902 is shown. However, in practice, the set of laser light sources may include any number of laser light sources, or a single laser light source that is dynamically (or statically) configurable.

The first laser light source 120 may emit a first beam of light 124, and the second laser light source 902 may emit a second beam of light 904. The first and second laser light sources 120, 902 may have different configurations or parameters, and the first and second beams of light 124, 904, may have different parameters. For example, the beams of light 124, 904 may have one or more of: different locations of origin (e.g., the laser light sources 120, 902 may have different positions); different beam axis tilts with respect to surfaces of a cover stack (e.g., the laser light sources 120, 902 may have different orientations, or a first axis 702 of the first beam of light 124 may intersect a surface of the cover stack 106 at a different angle than a second axis 906 of the second beam of light 904); different beam shaping or beam steering (which in some cases may include different beam divergences); different MFDs; different polarizations; and so on. The beams of light 124, 904 may illuminate the same areas, overlapping areas, or different areas of the cover stack 106 (or of the exterior surface 110 or 116 of the cover stack 106). The resulting illumination areas of the different beams of light 124, 904, on the exterior surface 110 or 116, may have a same size, approximate same size, or difference in size having any particular relationship. Cross-sections of the different beams of light 124, 904 may have the same or different shape(s).

Different MFDs may be provided, for example, by different configurations of the first and second laser light sources 120, 902, or by at least one optical element (e.g., optical element(s) 302 or 908) associated with the first laser light source 120 or the second laser light source 902. Different locations of origin may provide different baselines between the laser light sources 120, 902 and the image sensor 122.

The control circuit 128 (e.g., a processor, or DSP circuitry) may be operable to independently switch each of the first laser light source 120 and second laser light source 902 on and off. In this manner, a particular laser light source or set/subset of laser light sources may be turned on for a particular cover stack thickness or sensing scenario. In some embodiments, the control circuit 128 may turn on only a first one or more of the laser light sources 120, 902; acquire a first one or more laser speckle images using the image sensor 122; turn on only a second one or more of the laser light sources 120, 902 (e.g., a different light source or combination of light sources); acquire a second one or more laser speckle images using the image sensor 122; and then determine which of the first or second one or more laser speckle images has a preferred speckle size, contrast, or other parameter(s). The one or more light sources that provide the preferred speckle size, contrast, or other parameter(s) may then be selected for sensing a target 142 through the cover stack 106. The one or more light sources may be selected for use indefinitely, or for a period of time before the control circuit 128 acquires and evaluates new laser speckle images and selects a new one or more light sources for performing sensing.

In some embodiments of the opto-electronic device 900 that are used for sensing through different cover stack thicknesses (e.g., thickness 112 or 118), the first light source 120 may have a first beam axis tilt and first full field angle divergence, and the second light source 902 may have a second beam axis tilt and second full field angle divergence (e.g., different beam axis tilts and different full field angle divergences). By way of example, the first beam axis tilt may be greater than the second beam axis tilt, and the first full field angle divergence may be greater than the second full field angle divergence. In some of these embodiments, the beam axis tilts and full field angle divergences, in combination with other parameters, may be selected such that the illumination area of the first light source 120, on the exterior surface 110 of the cover 104, is approximately the same size as the illumination area of the second light source 902 on the exterior surface 116 of the screen protector 114. In some embodiments, the first beam axis tilt and first full field angle divergence may be selected to mitigate, eliminate, control, or purposefully limit or direct flare or strong relative illumination on the image sensor 122, while also increasing light collection efficiency at the image sensor 122, when the first light source 120 is used for sensing with respect to the exterior surface 110 of the cover 104. However, the illumination provided by the first light source 120 may have too great an illumination size on the exterior surface 116 of the screen protector 114 (which in turn produces a smaller speckle size with lower contrast). Furthermore, the illumination area of the first light source 120, on the exterior surface 116 of the screen protector 114 may be off-axis with respect to the image sensor 122 and result in a decreased light collection efficiency at the image sensor 122. Thus, when the screen protector 114 is present, the second light source 902 may be used for sensing. The second beam axis tilt and second full field angle divergence may be selected to increase light collection efficiency at the image sensor 122 when the second light source 120 is used for sensing with respect to the exterior surface 116 of the screen protector 114. The control circuit 128 may be configured to dynamically analyze (e.g., compare) 1) laser speckle images collected when the cover stack 106 is illuminated using the first light source 120 and 2) laser speckle images collected when the cover stack 106 is illuminated using the second light source 902. Based on the analysis, the control circuit 128 may determine whether to use the first light source 120 or the second light source 902 to illuminate the cover stack 106 during sensing.

Some embodiments of the opto-electronic device 900 may be tuned for sensing through a cover stack 106 having a static cover stack thickness, or may include different sets of light sources for sensing performed relative to different cover stack thicknesses. In this regard, some embodiments of the opto-electronic device 900 may include first and second light sources 120, 902 that are both tuned to sense through a particular cover stack thickness. In these embodiments, the first and second light sources 120, 902 may be tuned to provide illumination areas of different size on a same surface (e.g., on the exterior surface 110, or on the exterior surface 116). The light source that is tuned to provide the illumination area of smaller size (e.g., the first light source 120 may yield the larger speckle size and higher image contrast ratio. However, illumination size determines the highest possible tracking speed, so there is an intrinsic tradeoff between tracking accuracy (provided by larger speckle size and higher image contrast ratio) and tracking speed. Thus, the light source that is tuned to provide the illumination area of larger size (e.g., the second light source 902) may enable a higher tracking speed. Depending on a sensed speed of a target moving with respect to a sensing surface (e.g., the exterior surface 110 or the exterior surface 116), or depending on whether the control circuit 128 is able to detect movement of an object with respect to the sensing surface, the control circuit 128 may use the first light source 120 or the second light source 902 to illuminate the cover stack 106 during sensing.

In some embodiments, the opto-electronic device 900 (and other devices described herein) may be used to sense movement of a finger with respect to a surface other than a surface of a cover stack. For example, the devices described herein may be used to sense movement of a finger along a button (e.g., a movable button, or a protrusion having a surface over which a user may swipe, press, or otherwise move their finger or make a gesture) or a housing member (e.g., a side of a mobile phone or electronic watch).

The devices described herein may also be used to sense movement toward and away from a surface (e.g., a surface of a cover stack, button, or housing member). In some embodiments, the devices described herein may be used to sense movement of a finger or stylus in a wet environment, such as an environment in which a device is submerged in a liquid or otherwise wet. Movement in relation to a wet surface may be sensed when the liquid is still, transparent, or relatively slow-moving, and when a finger, stylus, or other sensed target has a distinguishable movement velocity in comparison to the liquid.

In general, the speckle size of a laser speckle pattern increases with increases in the MFD of a laser speckle sensor's laser light source. In general, better laser speckle tracking performance is provided by a laser speckle sensor when the laser speckle size of a laser speckle pattern, at an imaging plane of an image sensor, is of a same order of magnitude as (or approximately equal to) the pixel size of the image sensor. The better laser speckle tracking performance is at least in part due to better laser speckle contrast. For purposes of this description, “a same order of magnitude” is preferably a laser speckle size that equals a pixel size. However “a same order of magnitude” also includes, for example, a laser speckle size that is within 0.5, 0.75, 0.9, 1.1, 1.5, or 2.0 times a pixel size. A laser speckle size that is approximately equal to a pixel size is within 0.9 to 1.1 times a pixel size.

In some embodiments, a laser speckle size and image sensor pixel size may be statically selected or configured so that the laser speckle size and pixel size are of a same order of magnitude (or approximately equal). In some embodiments, laser light sources in a set of laser light sources may turned on or off to find one or more light sources that yield a laser speckle size and pixel size that are of a same order of magnitude (or approximately equal). In some embodiments, a set of one or more optical elements may be physically moved, or electrically or thermally reconfigured, so that a laser speckle size and pixel size are of a same order of magnitude (or approximately equal). In some embodiments, the resolution of an image sensor may be dynamically (or statically) reconfigured so that a laser speckle size and pixel size are of a same order of magnitude (or approximately equal).

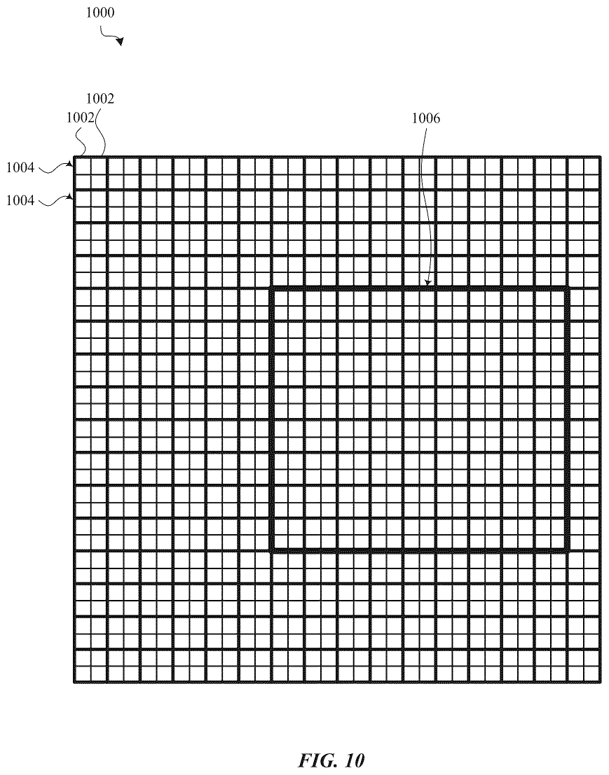

FIG. 10 shows an example plan view of an image sensor 1000. The image sensor 1000 may include a 2D array of pixels 1002. In some embodiments, the image sensor 1000 may be operated in a binned pixel mode or a non-binned pixel mode, depending on a determined laser speckle size or thickness of a cover stack. For example, the image sensor 1000 may be a quadra-pixel image sensor, in which a non-binned pixel value may be read out for each pixel 1002, or a binned pixel value may be read out for a 2×2 subset of four “binned” pixels 1004 (e.g., the ratio of non-binned pixels 1002 to binned pixels 1004 may be 4:1).

A control circuit (e.g., a processor, or DSP circuitry) may activate a laser light source, or determine which laser light source(s) in a set of laser light sources to activate, and operate at least a portion of the image sensor 1000 in the binned pixel mode or the non-binned pixel mode based on, for example: a laser speckle size determined from an acquired image or images (e.g., from an output of the image sensor 1000); or an estimated thickness of a cover stack determined from an acquired image or images. Alternatively, the control circuit may receive an indication of a cover stack thickness or cover stack layers (e.g., an indication received in the form of user input, or an indication received as machine input) and operate at least a portion of the image sensor 1000 in the binned pixel mode or the non-binned pixel mode.

In some embodiments, the control circuit may determine which pixels 1002 of the image sensor 1000 are affected by flare, distortion, or a loss of contrast, and identify a subset 1006 of pixels 1002 (e.g., a region of interest (ROI)) that is to be used for laser speckle tracking. In some embodiments, the control circuit may determine to operate the image sensor 1000 in a binned pixel mode or a non-binned pixel mode, in combination with using all of the pixels 1002 or a subset 1006 of pixels 1002 for laser speckle tracking.

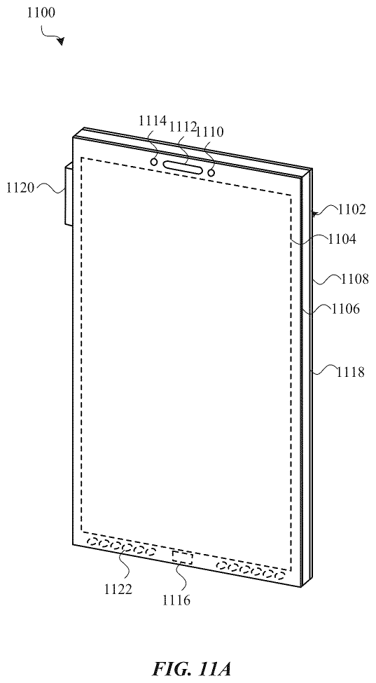

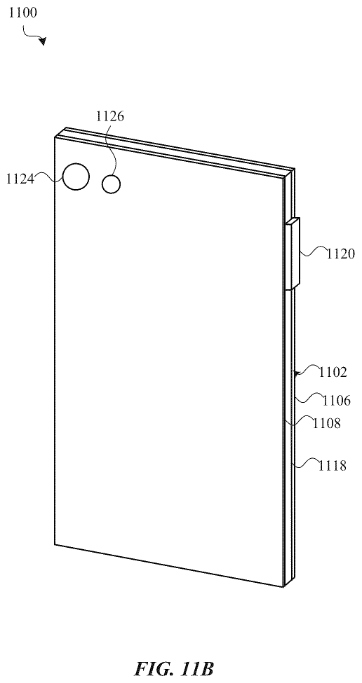

FIGS. 11A and 11B show an example of a device 1100 that may include a laser speckle flow sensor (or other type of optical sensor, thereby making the device 1100 an opto-electronic device, although the device 1100 may also have other purposes and functions). The device's dimensions and form factor, including the ratio of the length of its long sides to the length of its short sides, suggest that the device 1100 is a mobile phone (e.g., a smartphone). However, the device's dimensions and form factor are arbitrarily chosen, and the device 1100 could alternatively be any portable electronic device including, for example a tablet computer, portable computer, portable music player, wearable device (e.g., an electronic watch, health monitoring device, fitness tracking device, headset, or glasses), augmented reality (AR) device, virtual reality (VR) device, mixed reality (MR) device, gaming device, portable terminal, digital single-lens reflex (DSLR) camera, video camera, vehicle navigation system, robot navigation system, or other portable or mobile device. The device 1100 could also be a device that is semi-permanently located (or installed) at a single location. FIG. 11A shows a front isometric view of the device 1100, and FIG. 11B shows a rear isometric view of the device 1100. The device 1100 may include a housing 1102 that at least partially surrounds a display 1104. The housing 1102 may include or support a front cover 1106 or a rear cover 1108. The front cover 1106 may be positioned over the display 1104 and may provide a window through which the display 1104 may be viewed. In some embodiments, the display 1104 may be attached to (or abut) the housing 1102 and/or the front cover 1106. In alternative embodiments of the device 1100, the display 1104 may not be included and/or the housing 1102 may have an alternative configuration.

The display 1104 may include one or more light-emitting elements, and in some cases may be a light-emitting diode (LED) display, an organic LED (OLED) display, a liquid crystal display (LCD), an electroluminescent (EL) display, or another type of display. In some embodiments, the display 1104 may include, or be associated with, one or more touch and/or force sensors that are configured to detect a touch and/or a force applied to a surface of the front cover 1106.

The various components of the housing 1102 may be formed from the same or different materials. For example, a sidewall 1118 of the housing 1102 may be formed using one or more metals (e.g., stainless steel), polymers (e.g., plastics), ceramics, or composites (e.g., carbon fiber). In some cases, the sidewall 1118 may be a multi-segment sidewall including a set of antennas. The antennas may form structural components of the sidewall 1118. The antennas may be structurally coupled (to one another or to other components) and electrically isolated (from each other or from other components) by one or more non-conductive segments of the sidewall 1118. The front cover 1106 may be formed, for example, using one or more of glass, a crystal (e.g., sapphire), or a transparent polymer (e.g., plastic) that enables a user to view the display 1104 through the front cover 1106. In some cases, a portion of the front cover 1106 (e.g., a perimeter portion of the front cover 1106) may be coated with an opaque ink to obscure components included within the housing 1102. The rear cover 1108 may be formed using the same material(s) that are used to form the sidewall 1118 or the front cover 1106. In some cases, the rear cover 1108 may be part of a monolithic element that also forms the sidewall 1118 (or in cases where the sidewall 1118 is a multi-segment sidewall, those portions of the sidewall 1118 that are conductive or non-conductive). In still other embodiments, all of the exterior components of the housing 1102 may be formed from a transparent material, and components within the device 1100 may or may not be obscured by an opaque ink or opaque structure within the housing 1102.

The front cover 1106 may be mounted to the sidewall 1118 to cover an opening defined by the sidewall 1118 (e.g., an opening into an interior volume in which various electronic components of the device 1100, including the display 1104, may be positioned). The front cover 1106 may be mounted to the sidewall 1118 using fasteners, adhesives, seals, gaskets, or other components.

A display stack or device stack (hereafter referred to as a “stack”) including the display 1104 may be attached (or abutted) to an interior surface of the front cover 1106 and extend into the interior volume of the device 1100. In some cases, the stack may include a touch sensor (e.g., a grid of capacitive, resistive, strain-based, ultrasonic, optical, or other type of touch sensing elements), or other layers of optical, mechanical, electrical, or other types of components. In some cases, the touch sensor (or part of a touch sensor system) may be configured to detect a touch applied to an outer surface of the front cover 1106 (e.g., to a display surface of the device 1100). In some cases, the touch sensor may be implemented as a laser speckle flow sensor.

In some cases, a force sensor (or part of a force sensor system) may be positioned within the interior volume above, below, and/or to the side of the display 1104 (and in some cases within the device stack). The force sensor (or force sensor system) may be triggered in response to the touch sensor detecting one or more touches on the front cover 1106 (or a location or locations of one or more touches on the front cover 1106) and may determine an amount of force associated with each touch, or an amount of force associated with a collection of touches as a whole. In some embodiments, the force sensor (or force sensor system) may be used to determine a location of a touch, or a location of a touch in combination with an amount of force of the touch. In these latter embodiments, the device 1100 may not include a separate touch sensor.

As shown primarily in FIG. 11A, the device 1100 may include various other components. For example, the front of the device 1100 may include one or more front-facing cameras 1110 (including one or more 3D image sensors or depth sensors), speakers 1112, microphones, or other components 1114 (e.g., audio, imaging, and/or sensing components (e.g., a laser speckle flow sensor, such as one of the laser speckle flow sensors described herein)) that are configured to transmit or receive signals to/from the device 1100. In some cases, a front-facing camera 1110, alone or in combination with other sensors, may be configured to operate as a bio-authentication or facial recognition sensor. In some embodiments, a flash or electromagnetic radiation source (e.g., a visible or IR light source) may be positioned near the front-facing camera. In some cases, the front-facing camera 1110 may be positioned behind the display 1104 and receive electromagnetic radiation (e.g., light) through the display 1104. In some cases, a proximity sensor or depth sensor may be used to determine a distance to a user or generate a depth map of the user's face, or determine a distance or proximity to an object or generate a depth map of the object (or of objects in a field of view (FoV) that includes the object). The device 1100 may also include various input devices, such as one or more optical sensors 1116 (e.g., one or more laser speckle flow sensors). By way of example, optical sensor 1116 is shown to be positioned adjacent a lower edge of the display 1104. The optical sensor 1116 may sense through the front cover 1106, and may be used to track movement of a user's thumb or another finger (with the term “finger” broadly including any of a user's digits). Tracked movement of the user's thumb may be used, for example, to unlock the device 1100, to position an icon on a graphical user interface of the display 1104, to switch between screens of the graphical user interface, et cetera. Alternatively or additionally, an optical sensor may be provided in the button 1120, to detect movement on the button 1120; anywhere within the housing 1102 to detect movement on a surface of the housing; et cetera.

The device 1100 may also include buttons or other input devices positioned along the sidewall 1118 and/or on a rear surface of the device 1100. For example, a volume button or multipurpose button 1120 may be positioned along the sidewall 1118, and in some cases may extend through an aperture in the sidewall 1118. The sidewall 1118 may include one or more ports 1122 that allow air, but not liquids, to flow into and out of the device 1100. In some embodiments, one or more sensors may be positioned in or near the port(s) 1122. For example, an ambient pressure sensor, ambient temperature sensor, internal/external differential pressure sensor, gas sensor, particulate matter concentration sensor, or air quality sensor may be positioned in or near a port 1122.

In some embodiments, the rear surface of the device 1100 may include a rear-facing camera 1124 that includes one or more 3D image sensors or depth sensors (see FIG. 11B). A flash or electromagnetic radiation source 1126 (e.g., a visible or IR light source) may also be positioned on the rear of the device 1100 (e.g., near the rear-facing camera). In some cases, the rear surface of the device 1100 may include multiple rear-facing cameras.

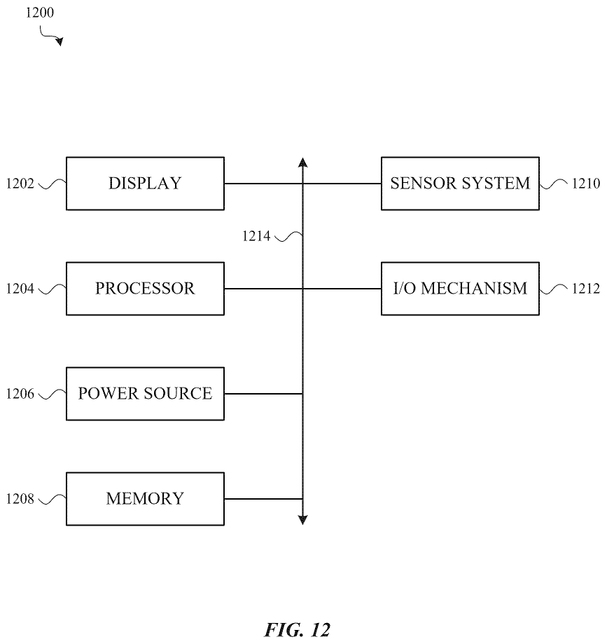

FIG. 12 shows a sample electrical block diagram of an electronic device 1200 that includes an optical sensor, such as a laser speckle flow sensor constructed or configured in accordance with the principles described with reference to any of FIGS. 1-11 or elsewhere in this description. The electronic device 1200 may take forms such as a hand-held or portable device (e.g., a smartphone, tablet computer, or electronic watch), a wearable device, a computing device, a navigation system of a vehicle, and so on. The electronic device 1200 may include an optional display 1202 (e.g., a light-emitting display), a processor 1204, a power source 1206, a memory 1208 or storage device, a sensor system 1210, and an optional input/output (I/O) mechanism 1212 (e.g., an input/output device and/or input/output port). The processor 1204 may control some or all of the operations of the electronic device 1200. The processor 1204 may communicate, either directly or indirectly, with substantially all of the components of the electronic device 1200. For example, a system bus or other communication mechanism 1214 may provide communication between the processor 1204, the power source 1206, the memory 1208, the sensor system 1210, and/or the input/output mechanism 1212.

The processor 1204 may be implemented as any electronic device capable of processing, receiving, or transmitting data or instructions. For example, the processor 1204 may be a microprocessor, a central processing unit (CPU), an application-specific integrated circuit (ASIC), a DSP, a controller, or any combination of such devices. As described herein, the term “processor” is meant to encompass a single processor or processing unit, multiple processors, multiple processing units, or another suitably configured computing element or elements.

In some embodiments, the components of the electronic device 1200 may be controlled by multiple processors. For example, select components of the electronic device 1200 may be controlled by a first processor and other components of the electronic device 1200 may be controlled by a second processor, where the first and second processors may or may not be in communication with each other.

The power source 1206 may be implemented with any device capable of providing energy to the electronic device 1200. For example, the power source 1206 may include one or more disposable or rechargeable batteries. Additionally or alternatively, the power source 1206 may include a power connector or power cord that connects the electronic device 1200 to another power source, such as a wall outlet, or a wireless charging circuit that connects the electronic device 1200 to a wireless charger.

The memory 1208 may store electronic data that may be used by the electronic device 1200. For example, the memory 1208 may store electrical data or content such as, for example, audio and video files, documents and applications, device settings and user preferences, timing signals, control signals, data structures or databases, image data, maps, or focus settings. The memory 1208 may be configured as any type of memory. By way of example only, the memory 1208 may be implemented as random access memory, read-only memory, Flash memory, removable memory, other types of storage elements, or combinations of such devices.

The electronic device 1200 may also include one or more sensors defining the sensor system 1210. The sensors may be positioned substantially anywhere on the electronic device 1200. The sensor(s) may be configured to sense substantially any type of characteristic, such as but not limited to, touch, force, pressure, electromagnetic radiation (e.g., light), heat, movement, relative motion, biometric data, distance, and so on. For example, the sensor system 1210 may include a touch sensor, a force sensor, a heat sensor, a position sensor, a light or optical sensor, an accelerometer, a pressure sensor (e.g., a pressure transducer), a gyroscope, a magnetometer, a health monitoring sensor, an image sensor, a proximity sensor, a laser speckle flow sensor, and so on. Additionally, the one or more sensors may utilize any suitable sensing technology, including, but not limited to, capacitive, ultrasonic, resistive, optical, ultrasound, piezoelectric, and thermal sensing technologies.

The I/O mechanism 1212 may transmit and/or receive data from a user or another electronic device. An I/O device may include a display, a touch sensing input surface such as a track pad, one or more buttons (e.g., a graphical user interface “home” button, or one of the buttons described herein), one or more cameras (including one or more 2D or 3D image sensors (e.g., one or more SPAD-based photon detectors)), one or more microphones or speakers, one or more ports such as a microphone port, and/or a keyboard. Additionally or alternatively, an I/O device or port may transmit electronic signals via a communications network, such as a wireless and/or wired network connection. Examples of wireless and wired network connections include, but are not limited to, cellular, Wi-Fi, Bluetooth, IR, and Ethernet connections. The I/O mechanism 1212 may also provide feedback (e.g., a haptic output) to a user.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

As described above, one aspect of the present technology may be the gathering and use of data available from various sources (e.g., user movements on a cover stack). The present disclosure contemplates that, in some instances, this gathered data may include personal information data (e.g., biological information (e.g., fingerprints), positional information, location information, or contextual information) that uniquely identifies or can be used to identify, locate, contact, or diagnose a specific person. Such personal information data can include demographic data, location-based data, telephone numbers, email addresses, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to activate or deactivate various functions of the user's device, or gather performance metrics for the user's device or the user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States (US), collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users may selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, et cetera), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

What is claimed is:

1. An opto-electronic device, comprising:
a cover stack separating an interior of the opto-electronic device from an exterior of the opto-electronic device; and
a laser speckle flow sensor positioned in the interior of the opto-electronic device and including,
a laser light source operable to emit a beam of light; and
an image sensor having a two-dimensional (2D) array of pixels, the image sensor positioned to receive a portion of the beam of light redirected from a target; wherein,
an axis of the beam of light intersects a surface of the cover stack at a non-perpendicular angle.

2. The opto-electronic device of claim 1, wherein a surface of the laser light source, from which the beam of light is emitted, is tilted toward or away from the image sensor and tilted with respect to the surface of the cover stack.

3. The opto-electronic device of claim 1, wherein the laser speckle flow sensor comprises at least one optical element positioned in a path of the beam of light, the at least one optical element tilting the axis of the beam of light and causing, at least in part, the axis of the beam of light to intersect the surface of the cover stack at the non-perpendicular angle.

4. The opto-electronic device of claim 1, wherein the laser speckle flow sensor comprises at least one optical element positioned in a path of the beam of light and changing a mode field diameter (MFD) of the beam of light from a native MFD to a target MFD.

5. The opto-electronic device of claim 1, wherein, for a cover stack thicknesses range of interest, the image sensor is positioned between the laser light source and a specular reflection of the beam of light from the surface of the cover stack.

6. The opto-electronic device of claim 1, wherein:
a specular reflection of the beam of light passes a first side of the laser light source; and
the image sensor is positioned on a second side of the laser light source, the second side opposite the first side.

7. The opto-electronic device of claim 1, further comprising:
a control circuit configured to,
operate at least a first portion of the 2D array of pixels in a binned pixel mode when a laser speckle size is determined to have a first size; and
operate at least a second portion of the 2D array of pixels in a non-binned pixel mode when the laser speckle size is determined to have a second size.

8. The opto-electronic device of claim 7, wherein the control circuit is configured to determine the laser speckle size from an output of the image sensor.

9. The opto-electronic device of claim 1, further comprising at least one optical polarization filter disposed over at least one pixel in the 2D array of pixels.

10. An opto-electronic device, comprising:
a laser speckle flow sensor, including,
a laser light source operable to emit a beam of light;
an image sensor having a two-dimensional (2D) array of pixels, the image sensor positioned to receive a portion of the beam of light redirected from a target; and
at least one optical element positioned to receive the beam of light and change a mode field diameter (MFD) of the beam of light, from a native MFD to a target MFD.

11. The opto-electronic device of claim 10, further comprising:
a cover stack separating an interior of the opto-electronic device from an exterior of the opto-electronic device, the laser speckle flow sensor positioned in the interior of the opto-electronic device, and the cover stack passing both,
the beam of light; and
a portion of the beam of light redirected from the target, the target exterior to the opto-electronic device.

12. The opto-electronic device of claim 11, wherein an axis of the beam of light intersects a surface of the cover stack at a perpendicular angle.

13. The opto-electronic device of claim 11, wherein a laser speckle size in the portion of the beam of light redirected from the target, at the image sensor, is of a same order of magnitude as a pixel size in the 2D array of pixels.

14. The opto-electronic device of claim 11, wherein the at least one optical element comprises at least one of:
an on-chip lens (OCL) formed in a substrate of the laser light source;
a lens attached to an epitaxial layer of the laser light source; or
a module lens positioned between the laser light source and the cover stack.

15. The opto-electronic device of claim 11, wherein the at least one optical element comprises a collimating lens.

16. The opto-electronic device of claim 11, further comprising an optical polarization filter positioned between the cover stack and the image sensor.

17. An opto-electronic device, comprising:
a cover stack separating an interior of the opto-electronic device from an exterior of the opto-electronic device;
a laser speckle flow sensor positioned in the interior of the opto-electronic device and including,
a set of laser light sources, at least a first laser light source in the set of laser light sources and a second laser light source in the set of laser light sources operable to emit respective first and second beams of light having different parameters;
an image sensor positioned to receive a portion of at least the first beam of light or the second beam of light, the portion of at least the first beam of light or the second beam of light redirected from a target; and
a control circuit operable to independently switch each of the first laser light source and the second laser light source on and off.

18. The opto-electronic device of claim 17, wherein:
the first laser light source emits a first beam of light having a first axis;
the second laser light source emits a second beam of light having a second axis; and
the first axis and the second axis intersect a surface of the cover stack at different angles.

19. The opto-electronic device of claim 17, wherein:
the first beam of light is associated with a first mode field diameter (MFD);
the second beam of light is associated with a second MFD, the second MFD different from the first MFD; and
the first MFD and the second MFD are provided by different configurations of the first laser light source and the second laser light source, or by at least one optical element associated with the first laser light source or the second laser light source.

20. The opto-electronic device of claim 17, wherein:
the first laser light source has at least one of a first position or a first orientation with respect to the image sensor;
the second laser light source has at least one of a second position or a second orientation with respect to the image sensor; and
at least the second position differs from the first position or the second orientation differs from the first orientation.
